(19) United States
(12) Patent Application Publication
(10) Pub. No.: US 2026/0116334 A1
(43) Pub. Date: Apr. 30, 2026

(54) Vehicle Safety Device with Intumescent Material

(71) Applicant: Joyson Safety Systems Acquisition LLC, Auburn Hills, MI (US)

(72) Inventors: Michael Newlin, Huntington Woods, MI (US); Andrea Revels-Thompson, Oxford, MI (US)

(21) Appl. No.: 19/375,635

(22) Filed: Oct. 31, 2025

Related U.S. Application Data
(60) Provisional application No. 63/714,589, filed on Oct. 31, 2024.

(51) Int. Cl. B60R 21/264; B60R 21/26

(52) U.S. Cl. CPC B60R 21/264; B60R 2021/26011; B60R 2021/2607; B60R 2021/26082

(57) ABSTRACT

An inflator comprises a housing having a base, a wall extending from the base, and an inner volume at least partially defined by the base and the wall. A pyrotechnic gas generant material is disposed within the inner volume and an intumescent material is also disposed within the inner volume. The base may have an inner surface and an outer surface, and the wall may also have an inner surface and an outer surface. The inner surface of the base and the inner surface of the wall face the inner volume. The intumescent material may be in contact with the inner surface of the base and/or the inner surface of the wall. Alternatively, the intumescent material may be disposed outside the inner volume and may be in contact with the outer surface of the base and/or the outer surface of the wall. An airbag module may include the inflator.

### CROSS REFERENCE TO RELATED APPLICATIONS

This application claims the benefit of U.S. Provisional Patent Application No. 63/714,589 filed on October 31, 2024, the entire contents of which are incorporated herein by reference.

### TECHNICAL FIELD

The present disclosure relates to safety devices for passenger vehicles. In particular, the disclosure relates to airbags and airbag inflators, both incorporating intumescent materials. Passenger vehicles may include, for example, automobiles, boats, trains, aircrafts, and spacecrafts.

### BACKGROUND

Airbags have been widely adopted in passenger vehicles, such as automobiles, for improving the safety of vehicle occupants. An inflator is operated by an ignition signal received from the vehicle when a vehicle sensor detects an emergency event, such as a collision, and inflates the airbag to a position between an occupant and a portion of the vehicle. The inflator is typically required to produce a sufficient amount of inflation gas to inflate the airbag in a very short period of time. In some inflators, pyrotechnic gas generant materials are used which can rapidly combust and produce the required inflation gas.

Because the rapid combustion of pyrotechnic gas general materials creates a significant amount of heat, management of that heat is critical for ensuring the structural integrity of the airbag throughout the emergency event. Additionally, prior to installation in an airbag module, the inflator must be able to withstand high levels of heat during transportation fires, which may occur, for example, during bulk transport of the inflators to an airbag manufacturing facility. In that scenario, the inflators must be able to automatically deploy safely prior to any response by emergency personnel. Therefore, there is a continuing need for improved heat management for airbags and their inflators before and during deployment.

### SUMMARY

In some implementations, an inflator comprises a housing. The housing comprises a base, a wall extending from the base, and an inner volume at least partially defined by the base and the wall. A pyrotechnic gas generant material is disposed within the inner volume and an intumescent material is disposed within the inner volume.

In some implementations, the base comprises an inner surface and an outer surface and the wall comprises an inner surface and an outer surface, the inner surface of the base and the inner surface of the wall facing the inner volume. In some implementations, the intumescent material is in contact with the inner surface of the base. In some implementations, the intumescent material is in contact with the inner surface of the wall. In some implementations, the intumescent material is in contact with the inner surface of the base and is further in contact with the inner surface of the wall.

In some implementations, the inflator further comprises a filter disposed within the inner volume. In some implementations, the intumescent material is in contact with the filter.

In some implementations, the inflator further comprises a cushion in contact with the pyrotechnic gas generant material, wherein the cushion is comprised of the intumescent material.

In other implementations, an inflator comprises a housing. The housing comprises a base, a wall extending from the base, and an inner volume at least partially defined by the base and the wall. A pyrotechnic gas generant material is disposed within the inner volume and an intumescent material is disposed outside of the inner volume.

In some implementations, the base comprises an inner surface and an outer surface and the wall comprises an inner surface and an outer surface, the inner surface of the base and the inner surface of the wall facing the inner volume. In some implementations, the intumescent material is in contact with the outer surface of the base. In some implementations, the intumescent material is in contact with the outer surface of the wall. In some implementations, the intumescent material is in contact with the outer surface of the base and is further in contact with the outer surface of the wall.

In some implementations, an airbag module comprises the inflator.

In other implementations, an airbag module comprises an occupant interface panel at least partially defining an inner volume, an inflator for releasing inflation gas into the inner volume, and a heat-resistant panel surrounding the inflator. The heat-resistant panel comprises an intumescent material.

In some implementations, the heat-resistant panel is coated with intumescent material. In some implementations, the heat-resistant panel is one panel of a plurality of heat-resistant panels. In some implementations, only one of the heat-resistant panels of the plurality of heat-resistant panels comprises the intumescent material. In other implementations, more than one of the heat-resistant panels of the plurality of heat-resistant panels comprises the intumescent material.

In some implementations, the heat-resistant panel comprises a woven fabric coated with the intumescent material.

### BRIEF DESCRIPTION OF THE DRAWINGS

The drawings are merely exemplary to illustrate steps, structure, and certain features that can be used singularly or in combination with other features. The disclosure should not be limited to the implementations shown.

FIG. 1 is a perspective view of an inflator for inflating an airbag.

FIG. 2 is a cross-sectional view of the inflator of FIG. 1 having an intumescent material, as taken through the plane A-A of FIG. 1.

FIGS. 3-8 are more cross-sectional views of the inflator of FIG. 1 with the intumescent material in various locations.

FIG. 9 is a cross-sectional view of an automobile cabin having an airbag module including the inflator of FIG. 1, as taken through a plane parallel to the central longitudinal axis of the automobile and passing through the airbag module.

FIG. 10 is a top-down view of a plurality of flattened out heat resistant panels of the airbag module of FIG. 9.

### DETAILED DESCRIPTION

The devices, systems, and methods disclosed herein provide for safety devices for use in passenger vehicles, such as automobiles. Specifically, airbags and airbag inflators may be used that incorporate intumescent materials. Inflators according to the present disclosure include an inner volume and the intumescent materials may be disposed within or outside of the inner volume. Furthermore, airbags may incorporate the inflators having intumescent materials and may, alternatively or additionally, include heat resistant panels comprising intumescent materials as a heat shield, as further described below. By incorporating intumescent materials, the airbags and inflators may passively control heat distribution and therefore improve safety and performance.

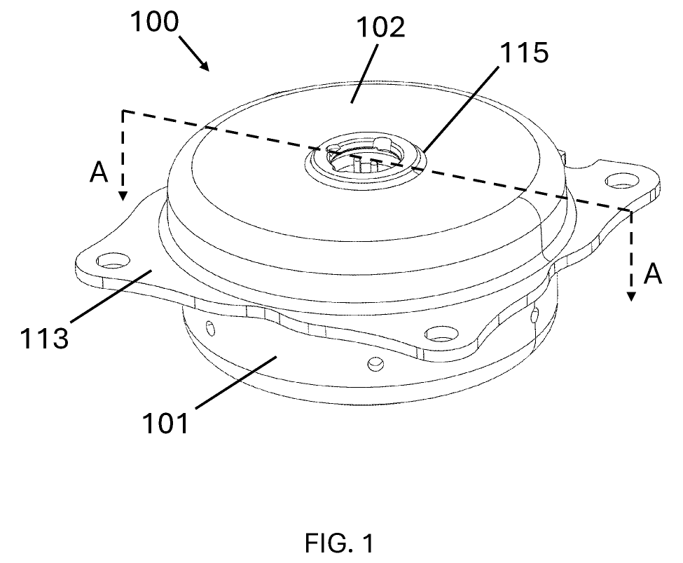

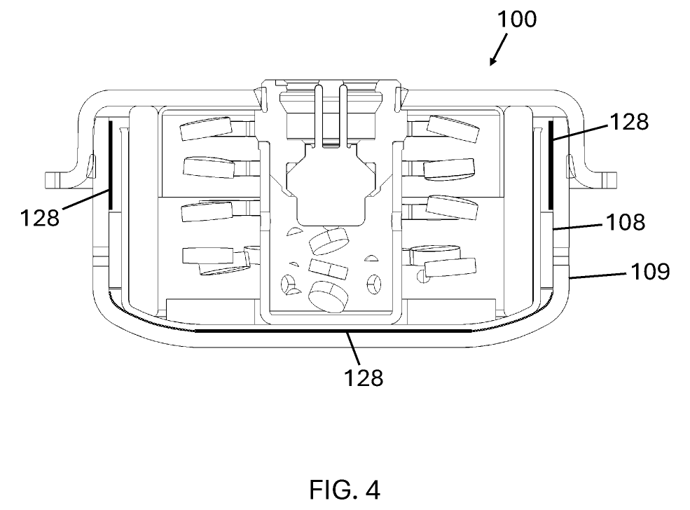

Referring to FIGS. 1-8, an inflator 100 comprises a housing 101 and a cap 102. The housing 101 comprises a base 104 and a wall 107 extending from the base 104. The wall 107 may include a transition portion 110 forming a radius of curvature between the wall 107 and the base 104, as shown in the FIGURES. Other inflator designs may have no transition portion 110 and the wall 107 and the base 104 may come together at a right angle. The base 104 comprises an inner surface 105 and an outer surface 106, while the wall 107 comprises an inner surface 108 and an outer surface 109. The base 104 and the wall 107 of the housing 101 at least partially define an inner volume 103 within which multiple other inflator 100 components are disposed.

The housing 101 and the cap 102 may be made of metal, for example stainless steel. A weld 117 may couple the housing 101 to the cap 102 to at least partially seal the inner volume 103 from the outside environment. The weld 117 may be a laser weld, a friction weld, or any

other appropriate weld for coupling metal components. In other implementations, the housing 101 and the cap 102 may be coupled together by a threaded engagement or adhesive. The cap 102 defines a flange 113 which defines mounting orifices for mounting the inflator 100 to an inflatable device, such as an airbag module 129 (described below). The cap 102 also defines a bore seal orifice 115 for receiving a bore seal 114. In some implementations, a weld 116, similar to weld 117, couples the bore seal 114 to the cap 102 around the perimeter of the bore seal orifice 115.

Bore seal 114 is configured to couple an initiator 119 to the inflator 100. The initiator 119 is coupled to the bore seal 114 in a sealed fashion by crimping the initiator 119 into the bore seal 114 with an o-ring 120 in between them. The initiator 119 is disposed partially within, and deploys into, a booster tube 118. The booster tube 118 extends within the inner volume 103. A booster gas generant 121 is disposed within the booster tube 118. A main gas generant 122 is disposed within the inner volume 103.

The inflator 100 further comprises an inner baffle 125, an outer baffle 127, and a filter 126 at least partially disposed between the inner baffle 125 and the outer baffle 127. The inner baffle 125, outer baffle 127, and filter 126 are disposed within the inner volume 103. A plenum 123 is formed between a portion of the inner surface 108 of the wall 107 and a portion of the outer baffle 127. During deployment of the inflator 100 (further discussed below), inflation gases will proceed through the filter 126, between the inner baffle 125 and outer baffle 127, into the plenum 123, and out of the inflator 100 via housing orifices 111 defined by the housing 101. Prior to deployment, the housing orifices 111 may be covered with a seal tape 112 to seal the inflator 100 at least partially from the outside environment. The seal tape 112 is configured to burst open at the housing orifices 111 to allow inflation gases 136 to exit the inflator 100.

The booster gas generant 121 and the main gas generant 122 may be pyrotechnic compositions that combust to form gas, heat, and/or molten solids. In some implementations, the booster gas generant 121 and the main gas generant 122 are different compositions. In other implementations, the booster gas generant 121 and the main gas generant 122 are the same composition. By way of non-limiting example, the booster gas generant 121 and the main gas generant 122 may be selected from the compositions disclosed in U.S. Patent No. 8,273,199 (Appendix A), U.S. Patent No. 10,214,460 (Appendix B), and U.S. Patent No. 10,358,393 (Appendix C).

Similarly, the initiator 119 is a pyrotechnic igniter. The initiator 119 may comprise pyrotechnic compositions that ignite upon the receipt of an electrical signal. The pyrotechnic compositions of the initiator 119 may be selected, for example, from zirconium potassium perchlorate (KPP), zirconium tungsten potassium perchlorate (ZWPP), and titanium potassium perchlorate (TPP). When the initiator 119 is ignited, combustion byproducts will ignite and combust the booster gas generant 121. Combustion byproducts from the booster gas generant 121 will leave the booster tube 118 to ignite the main gas generant 122. Combustion byproducts from the main gas generant 122, mostly gas, will exit the inflator 100 via housing orifices 111 and fill an airbag for protection of a vehicle occupant (i.e., inflation gases 136).

As noted above, the inflator 100 must be able to withstand high levels of heat during transportation fires, or during post-accident vehicle fires. Booster gas generant 121 may comprise an auto-igniting pyrotechnic composition which is capable of igniting in the presence of high levels of heat to safely deploy the inflator 100. However, in order for the auto-igniting pyrotechnic composition to function properly, heat from a fire must be preferentially directed to the booster gas generant 121 in the booster tube 118 rather than the main gas generant 122, which can be difficult to accomplish in all situations. Additionally, preventing as much heat as possible from reaching the main gas generant 122 can give more time for the booster gas generant 121 to safely auto-ignite.

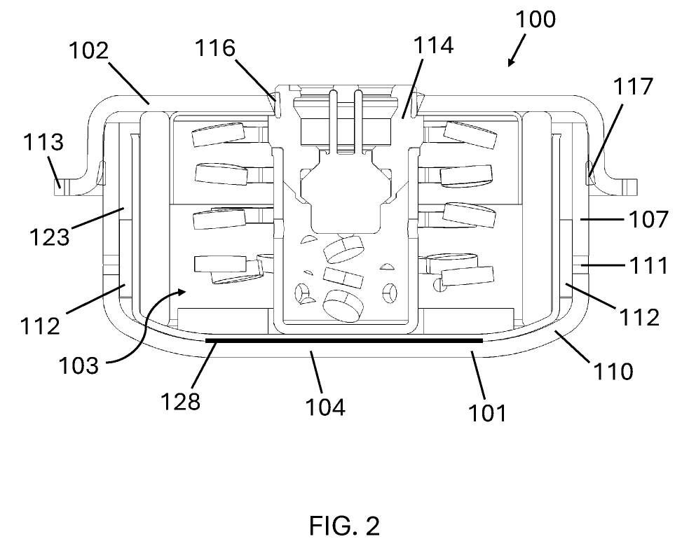

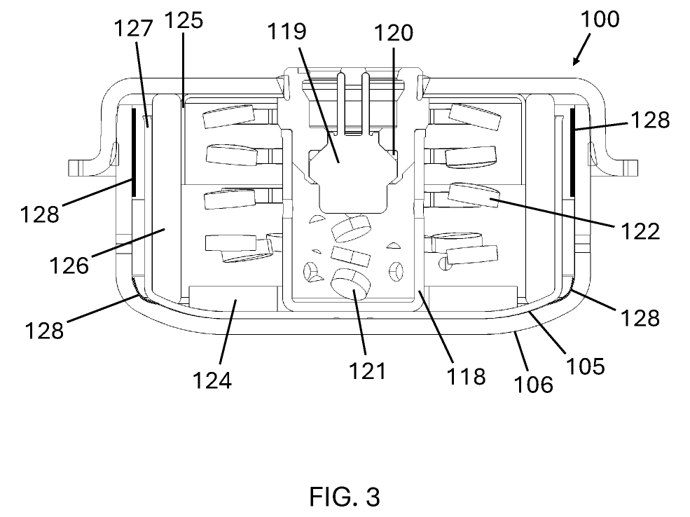

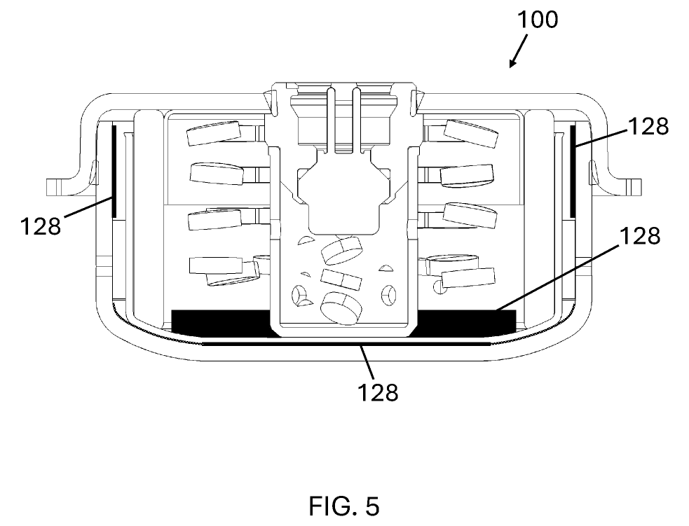

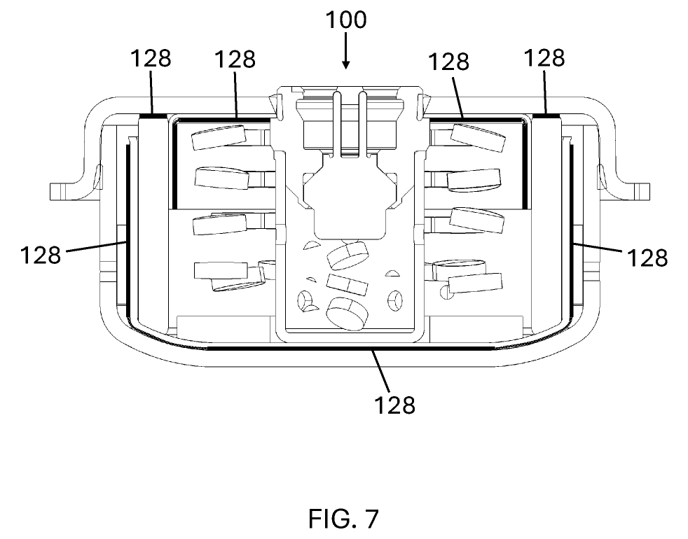

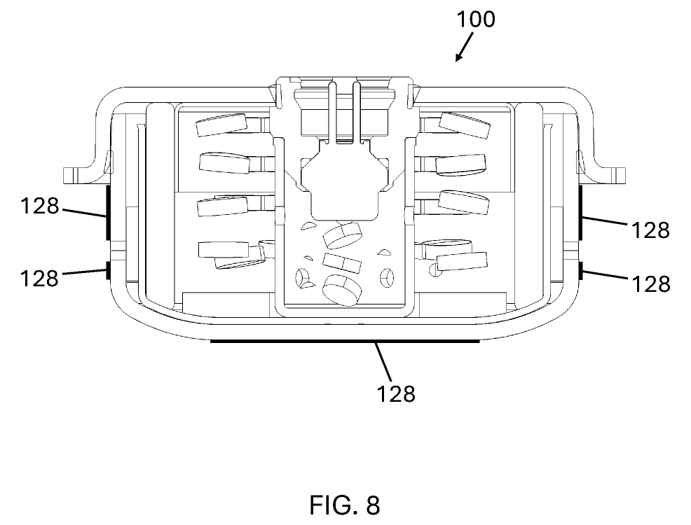

To improve heat transfer throughout the inflator 100, an intumescent material 128 may be disposed within the inner volume 103. The intumescent material 128 may be located in many different locations within the inner volume 103 depending on the specific design of the inflator 100. By way of nonlimiting example, the intumescent material 128 can be disposed on the inner surface 105 of the base 104 (FIGS. 2, 4, 5), the inner surface 108 of the wall 107 (FIGS. 3- 5), the inner surface 108 of the wall 107 in the region of the transition portion 110 (FIGS. 3-5), the inner baffle 125 (FIG. 7), the outer baffle 127 (FIG. 5), and the filter 126 (FIG. 7), or any combination thereof. Alternatively, as shown in FIG. 8, the intumescent material 128 may be disposed on the outer surface 106 of the base 104 and/or the outer surface 109 of the wall 107.

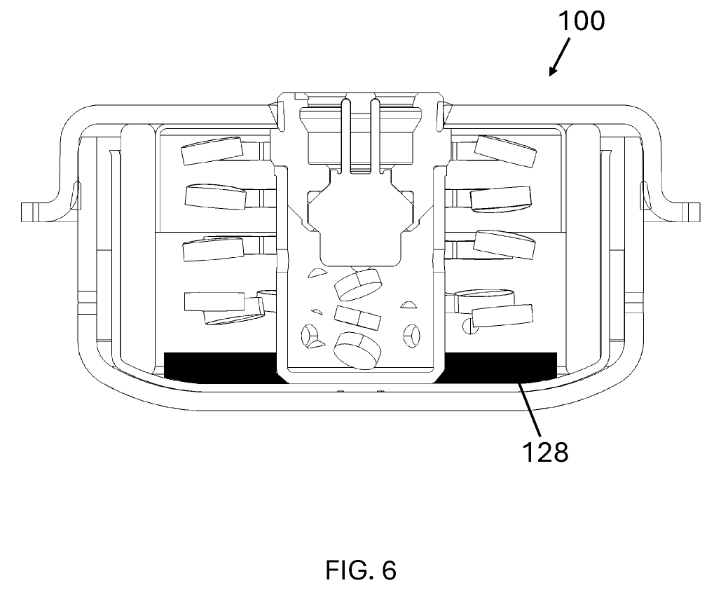

In some implementations, a cushion 124 may be made from the intumescent material 128 (FIGS. 5-6). In other implementations, the cushion 124 may be made from a ceramic material (e.g., woven or nonwoven ceramic fibers, FIGS. 2-4, 7-8). The cushion 124 is in contact with the main gas generant 122 in order to protect from the effects of heat and vibration. For example, the cushion 124 may prevent the main gas generant 122, in tablet form, from vibrating in place and grinding against other tablets, thereby preventing structural degradation. Additionally, the cushion 124 in ceramic form may provide some heat resistance to limit the amount of heat reaching the main gas generant 122 during a transportation fire. Forming the cushion 124 from the intumescent material 128 or coating the cushion 124 with the intumescent material 128 can provide higher levels of heat resistance, especially when used in combination with intumescent material 128 in other locations (FIG. 5).

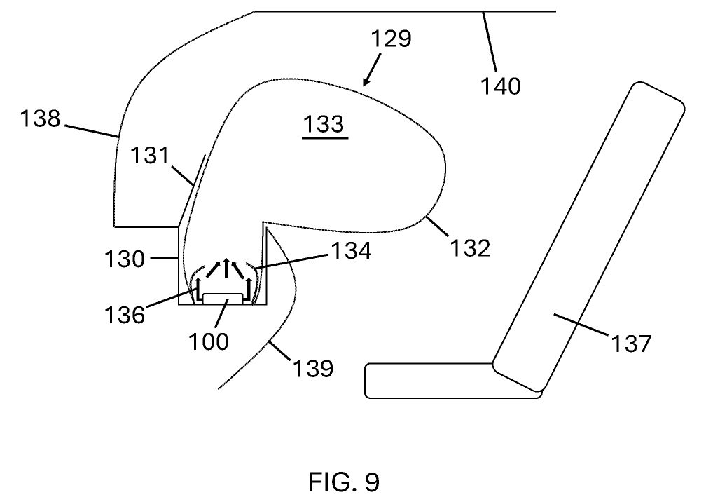

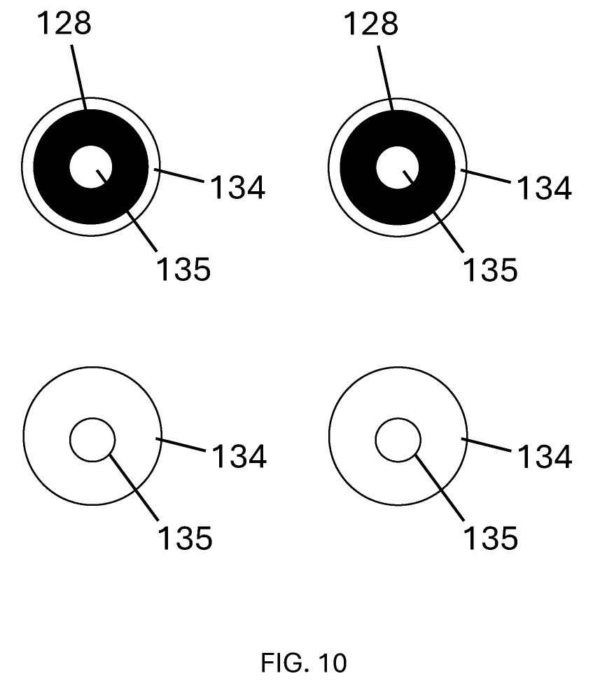

In some implementations, an airbag module 129 incorporates the inflator 100 comprising the intumescent material 128. The airbag module 129 may comprise an occupant interface panel 132 at least partially defining an inner volume 133, the inflator 100 for releasing inflation gas 136 into the inner volume 133, and a heat-resistant panel 134 surrounding the inflator 100. The heat-resistant panel 134 may comprise the intumescent material 128. As shown in FIGS. 9-10, the airbag module 129 may comprise a plurality of heat-resistant panels 134, with some of the plurality of heat-resistant panels 134 comprising the intumescent material 128 and some of the plurality of heat-resistant panels 134 not comprising the intumescent material 128. The plurality of heat-resistant panels 134 may be stacked one on top of the other such that the heat-resistant panels 134 with intumescent material 128 are closest to the housing orifices 111 of the inflator 100.

The heat-resistant panel 134 may comprise an opening 135 for inserting the inflator 100 into the airbag module 129, such that the heat-resistant panel 134 may surround but not completely cover the inflator 100. In this manner, the inflation gases 136 may leave the inflator at high speed and high temperature and then deflect off the heat-resistant panel 134 as they enter the inner volume 133. Therefore, the heat-resistant panel 134 with intumescent material 128 may absorb heat from the inflation gases 136 to prevent them from burning holes through the standard material of the occupant interface panel 132 (e.g., nylon or polyester). Using intumescent material 128 allows the airbag module 129 to use fewer layers of heat-resistant panels 134 than other airbags, thus reducing size, weight, and cost while improving performance.

The airbag module 129 may further comprise a housing 130 having a door 131. The housing 130 may be installed within a dashboard 139 of a vehicle. Prior to deployment, the occupant interface panel 132 may be folded up and stored within the housing 130 with the door 131 closed to make a seamless, aesthetic appearance on the dashboard 139. During deployment, the inflation gases 136 will fill the inner volume 133 and the occupant interface panel 132 will expand out into a space adjacent a windshield 138, a roof 140, and an occupant seat 137, as shown in FIG. 9, for interaction with a vehicle occupant during an emergency event (e.g., vehicle collision).

The intumescent material 128 is a material that can absorb heat causing an increase in volume and a decrease in density, thus further encompassing open volume in the region of the intumescent material. Additionally, intumescent materials 128 can produce a char upon expansion, which is a poor conductor of heat. For example, in the inflator 100, the char will help further redirect heat transfer to ideal locations (i.e., the location of the booster gas generant 121 or other auto-igniting gas generant material). In some implementations, the intumescent material 128 is a coating or a paste which can be applied to the various surfaces of the inflator 100 and/or heat-resistant panel 134, allowing for fine-tuning of the desired application. In some implementations, the intumescent material may be molded into desired shapes, such as the cushion 124, using traditional molding techniques (e.g., injection molding, casting, etc.).

A variety of intumescent materials 128 may be used for the present disclosure. In some implementations, the intumescent material 128 may include graphite, sodium silicates, melamine, melamine polyphosphate, titanium oxide, or ammonium polyphosphate. One example of an intumescent material 128, in paste form, includes 3M Brand Fire Barrier CP-25WB+, which is commercially available. By using these or other intumescent materials, automotive safety designers can ensure proper heat transfer throughout a variety of vehicle safety devices by selectively producing char and volume expansion in certain areas of the safety devices to control heat paths.

What is claimed is:

1. An inflator comprising:
a housing comprising:
a base;
a wall extending from the base; and
an inner volume at least partially defined by the base and the wall;
a pyrotechnic gas generant material disposed within the inner volume; and
an intumescent material disposed within the inner volume.

2. The inflator of claim 1, wherein the base comprises an inner surface and an outer surface and the wall comprises an inner surface and an outer surface, the inner surface of the base and the inner surface of the wall facing the inner volume.

3. The inflator of claim 2, wherein the intumescent material is in contact with the inner surface of the base.

4. The inflator of claim 2, wherein the intumescent material is in contact with the inner surface of the wall.

5. The inflator of claim 3, wherein the intumescent material is further in contact with the inner surface of the wall.

6. The inflator of claim 1, further comprising a filter disposed within the inner volume.

7. The inflator of claim 6, wherein the intumescent material is in contact with the filter.

8. The inflator of claim 1, further comprising a cushion in contact with the pyrotechnic gas generant material, wherein the cushion is comprised of the intumescent material.

9. An airbag module comprising the inflator of claim 1.

10. An inflator comprising:
a housing comprising:
a base;
a wall extending from the base; and
an inner volume at least partially defined by the base and the wall;
a pyrotechnic gas generant material disposed within the inner volume; and
an intumescent material disposed outside of the inner volume.

11. The inflator of claim 10, wherein the base comprises an inner surface and an outer surface and the wall comprises an inner surface and an outer surface, the inner surface of the base and the inner surface of the wall facing the inner volume.

12. The inflator of claim 11, wherein the intumescent material is in contact with the outer surface of the base.

13. The inflator of claim 11, wherein the intumescent material is in contact with the outer surface of the wall.

14. The inflator of claim 12, wherein the intumescent material is further in contact with the outer surface of the wall.

15. An airbag module comprising:
an occupant interface panel at least partially defining an inner volume;
an inflator for releasing inflation gas into the inner volume; and
a heat-resistant panel surrounding the inflator;
wherein the heat-resistant panel comprises an intumescent material.

16. The airbag module of claim 15, wherein the heat-resistant panel is coated with intumescent material.

17. The airbag module of claim 15, wherein the heat-resistant panel is one panel of a plurality of heat-resistant panels.

18. The airbag module of claim 17, wherein only one of the plurality of heat-resistant panels of the plurality of heat-resistant panels comprises the intumescent material.

19. The airbag module of claim 17, wherein more than one of the plurality of heat-resistant panels of the plurality of heat-resistant panels comprises the intumescent material.

20. The airbag module of claim 15, wherein the heat-resistant panel comprises a woven fabric coated with the intumescent material.
